(19) United States
(12) Patent Application Publication
(10) Pub. No.: US 2013/0149282 A1
(43) Pub. Date: Jun. 13, 2013

(54) FOOD-BASED UTENSILS AND STORAGE CONTAINERS AND METHODS OF MAKING THE SAME

(71) Applicant: David Christopher Marshall, Denver, CO (US)

(72) Inventor: David Christopher Marshall, Denver, CO (US)

(21) Appl. No.: 13/709,536

(22) Filed: Dec. 10, 2012

Related U.S. Application Data
(60) Provisional application No. 61/569,050, filed on Dec. 9, 2011.

(51) Int. Cl. A23L 1/00; A47G 21/00

(52) U.S. Cl. CPC A23L 1/0073; A47G 21/00
USPC 424/85.4; 426/390; 426/391; 426/385; 426/302; 426/85; 426/104; 426/72; 426/73; 426/74; 424/184.1; 514/56; 514/570; 514/221; 514/282; 424/718; 424/94.1

(57) ABSTRACT

The disclosure relates to edible and biodegradable eating utensils and edible and biodegradable containers. In one aspect a method of making and preserving an edible and biodegradable utensil or container is disclosed.

### CROSS REFERENCE TO RELATED APPLICATIONS

This application claims priority under 35 U.S.C. §119(e) to U.S. Provisional Application Ser. No. 61/569,050 filed on Dec. 9, 2011, which is incorporated herein in its entirety by this reference.

### FIELD OF THE INVENTION

The field of the invention relates to food and beverage utensils, accessories, containers and the like. More particularly, the field of the invention relates to edible and biodegradable eating and serving utensils such as forks, spoons, knives, straws, toothpicks, etc. and edible and biodegradable containers and methods of making the same.

### SUMMARY

A variety of different snack foods and/or drink products are packaged in relatively small, single serving containers. For example, yogurt, pudding, fruit, vegetables, cheeses, oatmeals, cereals, stew, soup, custard, ice cream, juice, milk, and other foods and beverages are available in single serving packages. Consumers have expressed a strong desirability in the convenience presented by this packaging technique. Namely, with a small, single serving package, the consumer is able to easily transfer the packaged food or beverage from one location (e.g., home) for consumption at another location (e.g., work, school, outdoor event, etc.), or provide a number of individuals with a single serving of the food or beverage item, for example, at an educational facility, sporting event or on an airplane. Some of the available single serving food products are consumable without the use of a separate eating utensil. For example, relatively solid snack food items, such as cheese sticks, fruit snacks, chips and candy bars, can be eaten by hand. Similarly, drink products, such as soda pop and fruit drinks, are typically consumed directly from the package or container, without the need for a utensil, unless they are consumed with a straw or straw/spoon combination. There has been an increase in demand of late from consumers for these types of products, for a number of reasons, including that these products do not require locating or disposing of a utensil, are more beneficial in reducing waste and protecting the environment, and may be consumed at various times of the day and in various locations without the need for heating, stirring, serving or preparing the product prior to consuming the product.

However, other single serving food and beverage products, including semi-solid consumable snack items such as yogurt, pudding, custard, cottage cheese, oatmeal, or food items that are normally eaten hot or cold, such as soup or ice cream, require a spoon, fork or similar utensil. In other words, relatively liquid snack food items not solid enough to be grasped by the consumer's hand or that have too high a viscosity to be drunken typically require a utensil. Along these same lines, the containers associated with semi-liquid food items are normally rigid and therefore do not facilitate direct consumption.

Consumers continue to demand snack food or beverage items packaged in convenient, single serving containers. However, for certain types of food, the requirement of a separate eating utensil may diminish purchasing enthusiasm for several reasons, including those mentioned above, such as poor environmental impact, or the inconvenience of requiring a disposable utensil to enjoy the food or beverage.

In still other food or beverage applications, foods may require mixing for best use prior to consumption. Furthermore, there are foods or beverages that may be enhanced by adding a flavor to the food or beverage product. For example, if a child is eating a chocolate pudding, it may be desirable to add a peanut butter or banana flavor to the pudding. Traditionally, this would require an additional container with the additional flavor, and the child would be required to mix the two contents prior to eating. Other enhancements to food or beverage products are only possible at or near the time of consumption (i.e., they cannot be combined when the product(s) is in storage), and therefore the consumer must have multiple items with them at the time of consumption in order to achieve the desired combination or enhancement.

Furthermore, children and some adults, are hesitant to take additives such as medicines, vitamins, minerals and supplements or forget to take these additives, which may be necessary for their diet and health, as required by their doctor. Enhancements to these items are often beneficial for the consumer and make the experience more enjoyable.

Many times, consumers may not have access to a proper utensil for eating their food. U.S. Pat. No. 6,371,324 discusses a portable food container cover having a detachable utensil with optimized performance and manufacturing characteristics and is incorporated by reference in its entirety. However, the portable food container and utensil will either need to be disposed of or carried back with the consumer to their home, for example, to ultimately end up in a landfill. Other problems exist in the art relating to quickly, safely and efficiently formulating edible utensils and containers and maintaining those utensils and containers in a desirable form and preserving the nutritional value of the item until it is ready to be consumed.

Thus, a need exists where the user is provided with utensils and containers that are edible and biodegradable, and that otherwise solve the problems associated with the current state of the art. The benefits, embodiments, and/or characterizations described herein are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying detailed description and examples provided below.

### DETAILED DESCRIPTION

Edible utensils known in the art include U.S. Publication No. 2006/0286214 entitled Edible Drinking Straw to Weiss et al., U.S. Publication No. 2004/0013772 entitled Edible Drinking Straw Fortified with Nutritional Supplements to Weiss et al., U.S. Publication No. 2007/0292566 entitled Edible Spoon for Administering Liquid Medications to DeGennaro, and U.S. Publication No. 2003/0072847 entitled Edible Supports for Non-frozen Comestibles Including Methods of Making and Decorating to Kiely, all of which are incorporated by reference in their entirety. Several methods may be used to freeze dry food products including U.S. Publication No. 2004/0031398 entitled Food Drying Machine to Jiang and U.S. Publication No. 2009/0317523 entitled Methods for Preparing Freeze Dried Foods to Hirschberg et al., both of which are incorporated by reference in their entirety. Methods may be used to flavor food, including the methods described in U.S. Pat. No. 5,958,474 entitled Process for Preparing Food Flavor Precursors to Lee et al., which is incorporated by reference in its entirety. Some methods include methods to flavor foods using a utensil including U.S. Publication No. 2007/0034093 entitled Cooking Utensil for Enhancing or Modifying Food Flavors to Nelson, which is incorporated by reference in its entirety.

The present invention is directed to an edible utensil and methods of making the same, and an edible container and methods of making the same. Advantageously, the utensil and/or container may be used to eat or serve other foods, and may be eaten themselves. Furthermore, the utensil and/or container is biodegradable if it is thrown away.

One aspect of the invention is a method of producing an edible utensil. The method comprises providing an edible material, producing a viscous edible material from the edible material, and forming the viscous edible material into a utensil. The edible material may be selected from any suitable material, including but not limited to, fruit, vegetables, meat, sweets, breads and combinations thereof.

Fruits may include any fruit or derivative thereof (for example, jams, sauces or purees), including but not limited to, apples, pears, apricot, cherry, plum, peach, grape, blackberry, dewberry, boysenberry, raspberry, cranberry, strawberry, fig, orange, grapefruit, clementine, lemon, lime, tangerine, avocado, lychee, guava, peanut, passion fruit, banana, coconut, date, mango, olive, pecan, pistachio, pineapple, papaya, pomegranate, watermelon, coffee, berries, honeydew, cantaloupe, tomato, melon, currant, dragon fruit, gooseberry, prune, nuts, kumquat, vanilla, pome fruits, stone fruits, temperate fruits, citrus, subtropical fruits, tropical fruits, and combinations thereof.

Vegetables may include any vegetable or derivative thereof (for example, jams, sauces, or purees), including but not limited to, leafy vegetables, fruiting vegetables, root vegetables, perennial vegetables, fungi, artichoke, arugula, asparagus, beans, beets, peppers, bell peppers, broccoli, Brussels sprouts, cabbage, carrots, cauliflower, celery, chard, collards, corn, cowpea, cucumber, eggplant, endive, fennel, garlic, gourd, hot peppers, Jerusalem artichoke, kale, kohlrabi, leek, lettuce, lima bean, spinach, melon, okra, onion, parsnip, pea, peanut, potato, pumpkin, radicchio, radish, rhubarb, rutabaga, squash, sweet potato, tomatillo, tomato, turnip, watermelon, cucurbits, peas, legumes, taro, truffles, mushrooms, ginger, plantain, water chestnut, wasabi, chives, shallot, bok Choy, quinoa, zucchini, alfalfa, lentil, anaheim pepper, fresno pepper, jalapeno pepper, pimiento/pimento pepper, poblano pepper, serrano pepper, ancho pepper, cascabel pepper, chipotle pepper, guajillo pepper, habañero pepper, pasada pepper, pasilla pepper, dill, parsley, bamboo, and combinations thereof.

Any suitable meat or derivative thereof (for example, sauces, gravies, or purees) may be used, including but not limited to, beef, pork, chicken, fish, bacon, crab, duck, goose, lamb, mutton, pheasant, partridge, poultry, quail, rabbit, turkey, venison, veal, boar, carabao, bison, camel, llama, goat, quail, ostrich, emu, guinea fowl, pigeon, frog, carp, catfish, salmon, halibut, shrimp, prawn, oysters, mussels, snails, caribou, and combinations thereof.

Sweets may include, but are not limited to, syrups, sauces, gummies, hard candy, lollies, sours, gum, chocolates, nuts, sugars, soft candies, liquorices, mints, spreads—including jams and peanut butter and the like, and combinations thereof.

It is understood for the purposes of this disclosure that the fruits, vegetables, meats, and sweets may be made into a puree, including for example, baby food. Furthermore, the fruits, vegetables, meats, sweets, and breads may also be combined with each other. Examples of combinations include fruits and/or sweets, such as strawberries and chocolate, or vegetable and meats, such as beef and carrots.

In another aspect of the invention, the utensil is flavored. Any other suitable complementary flavor may be used. Non-limiting examples of flavors include chocolate, fruit, animal, dairy, cream, butter, grains, sauces, condiments, nuts, salty, sour, sweet, bitter, sugary or a combination thereof. In still other aspects, at least one flavor of the utensil is dependent upon the material used to make the utensil. For example, if the utensil is made from dried strawberries, then the flavor of the utensil will be that of strawberries. Additional flavors may be added if desired. In other embodiments, at least one flavor is added to the utensil that does not necessarily correspond with the natural flavor of the utensil material. For example, the dried strawberry utensil may be made to taste at least partially like cream. Furthermore, the utensil may comprise several layers of flavors. For example, the outside of a utensil may be chocolate flavored, and the inside of the utensil is peanut butter flavored.

In some embodiments, the viscous edible material may be a puree of the edible material. The viscosity may be controlled and varied and may depend upon the forming operation. In some embodiments, the viscosity of the edible material may be greater than about 1.0 mPas (at 20° C.). As would be understood by one having skill in the art, the viscosity of a substance will be affected by the material and by the temperature. By way of non-limiting examples, the viscosity of apple puree may be about 1.5 mPas (at about 20° C.); the viscosity of baby food may be about 1.4 mPas (at about 40° C.); the viscosity of chocolate sauce may be about 280 mPas (at about 50° C.); the viscosity of fruit mash may be about 600 mPas (at about 20° C.); the viscosity of honey may be about 2 mPas (at about 40° C.); the viscosity of jam may be about 8.5 mPas (at about 20° C.); the viscosity of pudding may be about 1.0 mPas (at about 40° C.); and the viscosity of banana puree may be about 195 mPas (at about 20° C.).

The edible utensil may be formed using any suitable method, a number of which are described herein. By way of non-limiting example, the edible utensil may be formed by injection molding, pressing, shaving, cutting, laminating, extrusion molding, compaction, thermoforming, vacuum forming, casting, twisting, layering, drying, compression, combinations thereof and the like. The method of forming the utensil may determine the optimal viscosity of the material. By way of example, if the method of forming is injection molding, then it would be beneficial to use a material that had some viscous properties such that it did not, substantially leak from the mold, but that wasn't so vicious that it was difficult to inject.

In some embodiments, the edible material may be formed into the shape of the utensil or container with a mold. The mold(s) may be in the shape of a utensil or a container. By way of example but not limitation, suitable utensils may include a fork, a spoon, a spork, a knife, a serving device, a straw, a straw-spoon, a straw-fork, chopsticks, a skewer, a tong, a toothpick, a cocktail stick, a knork, a sporf, a chopfork, a chork, a splayd, and a spife.

The method in one embodiment may comprise providing a modular mold operable to selectively receive a plurality of sub-mold inserts in a plurality of configurable arrangements. The plurality of sub-mold inserts may correspond to one of a selection of the plurality of components for the utensil, and each sub-mold insert adapted to be operatively positioned within the modular mold in a plurality of arrangements. In one embodiment, the sub-mold inserts may be operatively positioned in the modular mold in an arrangement corresponding to the desired utensil or container cavity to form a utensil or container mold corresponding to the desired utensil or container.

In one embodiment, the utensil or container may be fabricated by injection molding. By way of example but not limitation, a desired utensil or container may be manufactured by injection molding using a modular insert injection mold, such as by use of injection molding equipment known to those of ordinary skill in the art and suitably sterilized for the food applications described herein. According to this embodiment, the modular injection mold may have at least one cavity side and at least one core side. Typically, a cavity side is also an injection side of the mold affixed to a stationary platen of the injection molding machine, and the core side is affixed to a movable platen of the injection molding machine, although the core side may be the ejection side of the mold and the cavity side may be the injection side of the mold. For the purposes of this disclosure, it is contemplated that ejection of the utensil or container item may be from the cavity side or the core side, and the cavity side and the core side may be adapted for mounting in the injection molding machine as desired by one skilled in the art.

The modular injection mold may be adapted to selectively receive a plurality of sub-mold inserts in a plurality of configurable arrangements, where each mold insert corresponds to one of the selection of the plurality of components for the fabrication of a utensil or container, such as those described herein and in the accompanying examples. The cavity side preferably includes a cavity plate having a rim cavity corresponding to at least a portion of the shape of the utensil or container perimeter. The rim cavity may correspond, at least in part, to the surface of the underside or topside of the utensil or container. In the interior of the rim cavity, a cavity insert aperture may be provided adapted to selectively receive a plurality of sub-mold cavity inserts in a plurality of configurable arrangements.

In one embodiment, the core side includes a mold plate having a rim core corresponding to at least a portion of the shape of the utensil or container. The rim core may correspond, at least in part, to the surface of the top or the sides of the utensil or container. In the interior of the rim core, a core insert aperture may be provided adapted to selectively receive a plurality of sub-mold core inserts in a plurality of configurable arrangements. The rim cavity and rim core may be shaped such that when the modular injection mold is closed the rim cavity and rim core form a cavity therebetween corresponding to the shape of a utensil or container perimeter.

In one particular embodiment, a plurality of sub-mold cavity inserts and sub-mold core inserts may also be provided, which are preferably shaped such that when closed in the modular injection mold, the mold cavity insert and mold core insert form a cavity therebetween in the shape of one of the selection of the plurality of components necessary for the fabrication of a utensil or container. The mold cavity insert and mold core insert are preferably shaped and sized such that a plurality of mold cavity inserts and mold core inserts are arranged to precisely fit in the cavity and core insert apertures according to the desired utensil or container. Certain sub-mold inserts may also be provided to fill spaces between a particular utensil or container component mold insert such that the cavity and core insert apertures are at least partially filled with sub-molds.

One or more clamp bolts may be provided through slots in the mold plate and cavity plate extending to the cavity and core insert apertures to bolt the sub-mold inserts in place. It is contemplated that other clamping systems may be utilized to hold the sub-mold inserts in the apertures.

The sub-mold inserts are preferably provided such that when closed in the modular injection mold in a plurality of various arrangements, the plurality of mold cavity inserts and plurality of mold core inserts form a continuous mold cavity therebetween in the shape of a component or the entirety of a particular utensil or container, according to the desired. The sub-mold inserts contact each adjacent sub-mold insert and the edge of the cavity and core insert apertures to reduce fluid food material flowing between the sub-mold inserts, causing extra food material to become formed about the perimeter in an undesirable or potentially dangerous manner.

The modular injection mold is preferably provided with one or more passages for the injection nozzle of the injection mold machine to inject fluid food material, such as of the type described herein, into the space between the mold cavity inserts and mold core inserts through a mold gate. The injection may be through one of the sub-mold cavity inserts, and the mold gate in the mold cavity surface of the sub-mold cavity insert. Alternatively, the mold gate may be provided in the rim cavity as an edge gate.

The sub-mold cavity inserts and sub-mold core inserts may include cooling passages for cooling the mold inserts during molding. Fluid ports may be provided on the sub-mold inserts, and corresponding cooling lines attached to each cooled sub-mold insert. In a preferred embodiment, each sub-mold cavity insert and sub-mold core insert is cooled independently from the other. The mold plate and cavity plate may also include slots positioned for cooling lines to pass through to the outside of the mold, where the cooling lines are attached to a cooling system.

In some embodiments, the method to produce an edible utensil may further include a drying the utensil. Drying may be accomplished by any suitable means known in the art. Some non-limiting examples of drying methods include, but are not limited to, baking the utensil, vacuum baking, dehydrating, and freeze drying. Baking may occur at a temperature greater than about 25° C. Vacuum baking may occur at a pressure less than atmospheric pressure and at a temperature greater than about 25° C.

In yet another embodiment, the method may comprise the steps of forming a plurality of discrete layers of a utensil, combining the plurality of discrete layers to form a utensil, bonding the plurality of discrete layers together and coating the plurality of discrete layers with one or more coating materials about at least a substantial portion of the exterior surface of the utensil to prevent the plurality of discrete layers from becoming disbanded and to preserve the nutritional and structural integrity of the utensil prior to consumption.

In yet another embodiment, the laminating and molding process described above may be combined, at least in part, to form a utensil or container such as the ones described herein.

In some embodiments, the method to produce an edible utensil may further comprise applying a coating material on the utensil. The coating material may be an additive, a sugar, a setting material, a flavor coating and combinations thereof. The coating material may be applied by dipping, spraying, painting or the like. The flavor of a coating material may be concealed by the flavor of the utensil, which may be based on the utensil material. In some embodiments, the flavor of the coating material may be complementary to the flavor of the edible material. For example, the edible material may be a potato and the coating material may be a combination of sour cream and butter.

In some embodiments, the coating material may be an additive. The additive may be at least one medicine, at least one vitamin, at least one supplement, at least one preservative, at least one thickening agent or combinations thereof. The additive may be added to the surface of the utensil after shaping and/or molding. Additionally, the additive may be added throughout the utensil, or it may be located in a particular location of the utensil, such as primarily in the handle of the utensil or on the rounded portion of a spoon, by way of example. Thus, even if only a portion of the utensil or container is eaten, the consumer will receive the additive. Additives may also be added as a distinct layer from another coating material or the utensil material.

In some embodiments, the additive is at least one medicine. The medicine may be a prescription, or in some embodiments, may be an over the counter medicine. Suitable medicines include, but are not limited to, antiacids, reflux suppressants, antiflatulents, antidopaminergics, dopaminergics, proton pump inhibitors, antihistamines, antiulcer, prostaglandin analogues, laxitives, bismuth compounds, anti motility, beta blockers, diuretics, nitrates, antianginals, vasoconstrictors, casodilators, ACE inhibitors, angiotensin receptor blockers, alpha blockers, anticoagulants, heparin, antiplatelet drugs, fibrinolytics, anti-hemophilic factors, haemostatic drugs, statins, antipsychotics, antidepressants, selective serotonin reuptake inhibitors, barbiturates, benzodiazepines, NSAIDS, opioids, vaccines, immunosuppressants, interferons, antibacterial, antibiotic, ibuprofen, and hydrocodone, or a combination thereof. In still other embodiments, a contrast media may be added to the utensil for use with a diagnostic machine. In still other embodiments, a numbing agent may be added to numb the mouth.

In some embodiments, the additive is a vitamin and/or mineral (collectively referred to as vitamins). Suitable vitamins include, but are not limited to, A, B₁, B₂, B₃, B₅, B₆, B₇, B₉, B₁₂, C, D, E, K, folic acid, biotin, iodine, potassium, chlorine, sodium, calcium, phosphorus, magnesium, zinc, iron, manganese, copper, selenium, molybdenum, chromium, pantothenic acid, a derivative or precursor thereof (by way of example beta carotene may be converted to Vitamin A), or a combination thereof.

In some embodiments, the additive is a supplement. Supplements include, but are not limited to, dietary supplements, food supplements, nutritional supplements, or body building supplements. Suitable supplements include, but are not limited to, herbs, protein, fiber, fatty acids, amino acids, Echinacea, ginger, ginkgo biloba, ginseng, glucosamine, lycopene, coenzyme Q-10 and combinations thereof The additive may include the correct dosage of a vitamin, medicine or supplement for a particular size of an individual.

The additive may be at least one preservative. Examples of preservatives may include, but not limited to, chemical preservatives, such as nitrates, sulfites, benzoates, butylates, BHA, sodium benzoate, sorbates, chelating acid, potassium sorbate, anti-oxidants, sorbic acid, propionic acid or propyl gallate; natural preservatives, such as salt, citric acid (like lemon or orange juice), acetic acid, sugar, spices, herbes; combinations thereof and the like.

The additive may be a thickening agent. The thickening agent may alter the viscosity of the utensil material. Typically, thickening agents increase the viscosity of a material, though it is understood that some agents may decrease the viscosity of a material. Suitable thickening agents include, but are not limited to, polysachandes, proteins, starch, vegetable gum, collagen, gelatin, sugar, sodium pyrophosphate, flour, grains, fumed silica, water, oil, combinations thereof and the like.

The utensil or container may comprise up to about 100% of the edible material. Thus, the entire utensil may comprise the edible material. In other embodiments, the utensil comprises between about 25% to about 90% of the edible material. In some embodiments, the utensil comprises about 25%, about 30%, about 35%, about 40%, about 45%, about 50%, about 55%, about 60%, about 65%, about 70%, about 75%, about 80%, about 85%, and about 90% of the edible material. In some embodiments, the utensil comprises about 85% of at least one coating material. In some embodiments, the utensil comprises between about 0% to about 50% of at least one coating material. In some embodiments, the utensil comprises about 0%, about 5%, %, about 10%, about 15%, about 20%, about 25%, about 30%, about 35%, about 40%, about 45%, and about 50% of at least one coating material.

The utensil may comprise residual nutrition based on the utensil material. In some embodiments, the residual nutrition may be greater than about 1% of the starting nutritional value. In some embodiments, the residual nutrition is greater than about 5%, greater than about 10%, greater than about 15%, greater than about 20%, greater than about 25%, greater than about 30%, greater than about 35%, greater than about 40%, greater than about 45%, greater than about 50%, greater than about 55%, greater than about 60%, greater than about 65%, greater than about 70%, greater than about 75%, greater than about 80%, greater than about 85%, and greater than about 90% of the starting nutritional value. The utensil may have a tensile strength of greater than about 10 MPa. In many embodiments, the tensile strength may be between about 5 MPa and about 1000 MPa. In some embodiments, the tensile strength is greater than about 50 MPa, greater than about 150 MPa, greater than about 200 MPa, greater than about 250 MPa, greater than about 300 MPa, greater than about 350 MPa, greater than about 400 MPa, greater than about 450 MPa, greater than about 500 MPa, greater than about 550 MPa, and greater than about 600 MPa. Reinforcement of the utensil may be used. Samples of reinforcement materials may include, but are not limited to, fiber, bread, flour, cheese, honey, and the like.

One aspect of the present disclosure comprises a method for producing an edible utensil, wherein the method includes providing an edible material, layering the edible material and forming the edible material into a utensil.

One aspect of the disclosure is a food-based utensil. The utensil may be in any suitable shape, including but not limited to, a fork, a spoon, a spork, a knife, a serving device, a straw, a straw-spoon, a straw-fork, chopsticks, a skewer, a tong, a toothpick, a cocktail stick, a knork, a sporf, a chopfork, a chork, a splayd, and a spife. The utensil material may be fruit based, vegetable based, bread based, meat based, a combination thereof or made of any other suitable food that may be dried or molded. The utensil material may be selected from any suitable material, including but not limited to, fruit, vegetables, meat, sweets, breads and combinations thereof.

One or more additive may be added to the utensil, which may be taken by the individual as required. Furthermore, the flavor of the additive may be concealed with the flavor of the utensil. The additive may include the correct dosage for a particular size of an individual. The additive may be at least one medicine, at least one vitamin, at least one supplement, or combinations thereof.

Another aspect of the invention is a packable meal comprising an edible utensil. The packable meal may be, by way of non-limiting example, a frozen meal, a fresh packaged meal, a refrigerated meal and dried goods. The packaged meal may be, by way of example, in a moisture resistant sealed package, an airtight package, individual packaged, or bulk packaged.

The edible utensil may be packaged for individual sale. Alternately, the edible utensils may be packaged in bulk (which may be individually wrapped). In another aspect of the invention, the utensil is packaged with a traditionally packaged food product, for example a snack food or drink product in single serving container, or with storage container of the present disclosure. Different flavors of the utensil may be packaged with a food product in order to achieve a desired flavor combination.

Another aspect of the disclosure is a food-based container. The container may be any suitable shape or size. In some embodiments, the container is a bag which may hold foods or liquids for an extended period of time without leaking In other embodiments, the container may be a vessel which may hold foods or liquids for an extended period of time without leaking In still other embodiments, the container may be used as a serving vessel. Similar to embodiments of the utensil, the container may be flavored and/or contain vitamins, medicine or supplements. The containers may be used to store foods, and then can be eaten. Furthermore, if the containers are thrown away, they are biodegradable.

The containers may be made by any suitable method. In some embodiments, the method described above for producing edible utensils may be used. Similarly, the containers may comprise the same materials as the utensil material and the same coating materials/additional materials. Subsequently, the properties of the containers may be similar to those of a utensil. In some embodiments, the container may be molded using a food-based material. In other embodiments, the utensil and container may be dried using techniques including but not limited to freeze drying, baking or desiccating.

### EXAMPLES

Some non-limiting examples of food and food-based flavored utensil combinations include:
Peanut butter sandwich and jelly flavored edible and biodegradable knife.
Chocolate pudding and banana flavored edible and biodegradable spoon.
Chocolate shake and an edible and biodegradable peanut butter flavored straw.
Peas and a carrot flavored edible and biodegradable spork, or alternatively a carrot flavored edible and biodegradable fork.
In a prepackaged dinner which might include mashed potatoes and a butter flavored or bacon flavored edible and biodegradable spork.
A cola and a cherry flavored edible and biodegradable straw.
A sweet fruit drink and a sour flavored edible and biodegradable straw.
A single serving of apple sauce and a cranberry flavored edible and biodegradable spoon, packaged together for sale.
A single serving of cottage cheese and a pineapple flavored edible and biodegradable spoon, packaged together for sale.
Single servings of yogurt of various flavors with a complimentary flavored edible and biodegradable spoon, packaged together for sale.
Single servings of various types of fruit cups with a complimentary flavored edible and biodegradable spoon, packaged together for sale.
Single serving of oatmeal with a strawberry and cream, brown sugar or other complimentary flavored edible and biodegradable spoon, packaged together for sale.

The foregoing discussion of the disclosure has been presented for purposes of illustration and description. The foregoing is not intended to limit the disclosure to the form or forms disclosed herein. In the foregoing Description of the Embodiments for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

1. A method of producing an edible utensil, the method comprising:
providing an edible material;
producing a viscous edible material from the edible material; and
forming the viscous edible material into a utensil.

2. The method of claim 1, wherein the edible material is selected from the group consisting of fruit, vegetables, meat, sweets, breads and combinations thereof.

3. The method of claim 1, wherein a viscosity of the edible material is greater than about 1.0 mPas.

4. The method of claim 1, wherein the edible material is formed into the shape of the utensil with a mold.

5. The method of claim 4, wherein the mold is in a shape of the utensil.

6. The method of claim 1, wherein the utensil is selected from the group consisting of a fork, a spoon, a spork, a knife, a serving device, a straw, a straw-spoon, a straw-fork, chopsticks, a skewer, a tong, a toothpick, a cocktail stick, a knork, a sporf, a chopfork, a chork, a splayd, and a spife.

7. The method of claim 1, further comprising drying the utensil.

8. The method of claim 7, wherein the utensil is dried by baking the utensil.

9. The method of claim 8, wherein a temperature of baking is greater than about 25° C.

10. The method of claim 7, wherein the utensil is dried by vacuum baking the utensil.

11. The method of claim 10, wherein the vacuum baking occurs at a pressure less than about 1 atm and a temperature greater than about 25° C.

12. The method of claim 7, wherein the utensil is dried by dehydrating the utensil.

13. The method of claim 7, wherein the utensil is dried by freeze drying.

14. The method of claim 1, further comprising spraying a coating material on the utensil.

15. A method of producing an edible utensil, the method comprising:
providing an edible material;
layering the edible material; and
forming the edible material into a utensil.

16. An edible utensil, the edible utensil comprising:
a edible material, wherein the edible material is selected from the group consisting of fruit, vegetables, meat, sweets, breads and combinations thereof, and wherein the edible utensil is in a shape selected from the group consisting of a fork, a spoon, a spork, a knife, a serving device, a straw, a straw-spoon, a straw-fork, chopsticks, a skewer, a tong, a toothpick, a cocktail stick, a knork, a sporf, a chopfork, a chork, a splayd, and a spife.

17. The edible utensil of claim 16, further comprising at least one additive.

18. The edible utensil of claim 17, wherein the additive is a medicine selected from the group consisting of antiacids, reflux suppressants, antiflatulents, antidopaminergics, dopaminergics, proton pump inhibitors, antihistamines, antiulcer, prostaglandin analogues, laxitives, bismuth compounds, anti motility, beta blockers, diuretics, nitrates, antianginals, vasoconstrictors, casodilators, ACE inhibitors, angiotensin receptor blockers, alpha blockers, anticoagulants, heparin, antiplatelet drugs, fibrinolytics, anti-hemophilic factors, haemostatic drugs, statins, antipsychotics, antidepressants, selective serotonin reuptake inhibitors, barbiturates, benzodiazepines, NSAIDS, opioids, vaccines, immunosuppressants, interferons, antibacterial, antibiotic, ibuprofen, hydrocodone, and a combination thereof

19. The edible utensil of claim 17, wherein the additive is a vitamin selected from the group consisting of A, B₁, B₂, B₃, B₅, B₆, B₇, B₉, B₁₂, C, D, E, K, folic acid, biotin, iodine, potassium, chlorine, sodium, calcium, phosphorus, magnesium, zinc, iron, manganese, copper, selenium, molybdenum, chromium, pantothenic acid, a derivative of a vitamin, a precursor of a vitamin, and combination thereof.

20. The edible utensil of claim 17, wherein the additive is a supplement, wherein the supplement is selected from the group consisting of dietary supplements, food supplements, nutritional supplements, or body building supplements. Suitable supplements include, but are not limited to, herbs, protein, fiber, fatty acids, amino acids, Echinacea, ginger, ginkgo biloba, ginseng, glucosamine, lycopene, coenzyme Q-10 and combinations thereof.
